(19) United States
(12) Patent Application Publication
(10) Pub. No.: US 2004/0063460 A1
(43) Pub. Date: Apr. 1, 2004

(54) Cellular phone provided with function of editing and displaying electronic mail data per communication counterpart

(75) Inventors: Mutsuharu Takesada, Yokohama-shi (JP); Norikazu Yamagishi, Yokohama-shi (JP); Takaaki Habara, Yokohama-shi (JP); Makoto Horikawa, Yokohama-shi (JP); Mina Imai, Yokohama-shi (JP)

Correspondence Address: Christopher J. Fildes, Fildes & Outland, P.C., Suite 2, 20916 Mack Avenue, Grosse Pointe Woods, MI, 48236, US

(73) Assignee: Hitachi Electronic Service Co. Ltd.

(21) Appl. No.: 10/457,621

(22) Filed: Jun. 9, 2003

(30) Foreign Application Priority Data
Sep. 27, 2002 (JP) 2002-283330

(51) Int. Cl. H04M 1/00

(52) U.S. Cl. 455/556.1; 455/412.1

(57) ABSTRACT

A cellular phone 1 comprising an overall control unit 10, an operation unit 11, a display 12, a transmission/reception unit 13, an inbox 14 for storing received electronic mail data, an outbox 15 for storing transmitted electronic mail data, and a power source 16, wherein the cellular phone is further provided with a function of displaying electronic mail data transmitted to and/or received from a selected communication counterpart in a mixed state.

### FIELD OF THE INVENTION

The present invention relates to a cellular phone having a function of editing and displaying electronic mail data per communication counterpart.

### DESCRIPTION OF THE RELATED ART

Heretofore, when an electronic mail data is transmitted and/or received using a cellular phone, the transmitted and/or received electronic mail is stored in an outbox or an inbox. The stored electronic mail can be read out and displayed when necessary.

FIG. 5 shows the transmission and reception status of the conventional electronic mail data.

The transmission/reception status of electronic mail data between an owner A of a cellular phone and a communication counterpart B and a communication counterpart C on day X of month Z is as shown in FIG. 5(a).

The owner A sends an electronic mail data titled a1 to the counterpart B at 9:00 a.m., receives an electronic mail data titled b1 from the counterpart B at 9:05 a.m., and receives an electronic mail data titled c1 from the counterpart C at 9:10 a.m. The transmission/reception is repeated, until the owner A receives an electronic mail data titled b2 from the counterpart B at 9:35 a.m., receives an electronic mail data titled c3 from the counterpart C at 9:40 a.m., and transmits an electronic mail data titled a5 to the counterpart C at 9:45 a.m.

During such transmission and reception of data made by the owner A, the transmission data is stored in transmission log A (transmission folder or outbox) in a manner shown in FIG. 5(b). The reception data is stored in reception log A (reception folder or inbox) in a manner shown in FIG. 5(c). The electronic mail data can be read out from the log and displayed on the cellular phone when necessary.

In the transmission log A, the transmitted electronic mail data on day X of month Z is listed in order of time with the latest electronic mail listed at the top. That is, the transmission log A stores the electronic mail data titled a5 sent to the counterpart C at 9:45 a.m., the electronic mail data titled a4 sent to the counterpart B at 9:30 a.m., the electronic mail data titled a3 sent to the counterpart C at 9:25, the electronic mail data titled a2 to the counterpart C at 9:15, and the electronic mail data titled a1 sent to the counterpart B at 9:00 a.m., respectively.

Also, in the reception log A, the received electronic mail data on day X of month Z is listed in the order of time with the latest electronic mail listed at the top. The reception log A stores the electronic mail data titled c3 sent from the counterpart C at 9:40 a.m., the electronic mail data titled b2 sent from the counterpart B at 9:35 a.m., the electronic mail data titled c2 sent from the counterpart C at 9:20, the electronic mail data titled c1 sent from the counterpart C at 9:10, and the electronic mail data titled b1 sent from the counterpart B at 9:05 a.m., respectively.

There has been provided a cellular phone equipped with a function of automatically sorting the received electronic mail data into individual folders (boxes).

However, such cellular phone is incapable of displaying in a mixture both the transmission/reception data of electronic mail communicated between a selected communication counterpart. Also, such cellular phone is incapable of displaying the transmitted/received electronic mail data with respect to each individual, nor with respect to a selected item (such as the time or time range, a keyword included in the title or content of transmission/reception (main text), or a title).

### SUMMARY OF THE INVENTION

The object of the present invention is to enable the transmitted and/or received electronic mail data with a selected communication counterpart to be displayed in a mixed (combined) state.

Also, another object of the present invention is to enable the transmitted and/or received electronic mail data communicated with a given counterpart to be displayed with respect to a predetermined item (such as time or time group, a keyword included in a title or content of transmission/reception (main text), or a title).

In order to achieve the above-mentioned object, the present invention provides a cellular phone 1 comprising an overall control unit 10, an operating unit 11, a display unit 12, a transmission/reception unit 13, an inbox 14 for storing received electronic mail data, an outbox 15 for storing transmitted electronic mail data, and a power source 16, wherein the cellular phone is further provided with a function of displaying electronic mail data transmitted to and received from a selected communication counterpart in a mixed state.

Also, the present invention provides a cellular phone mentioned above, wherein the cellular phone is further provided with a function of displaying the electronic mail data in the order related to a predetermined item selected from the group consisting of time or time group, a keyword included in a title or content (main text), and a title.

Moreover, the present invention provides a cellular phone mentioned above, wherein the cellular phone is further provided with a function of reading out received or transmitted data with respect to a given communication counterpart, editing said data, and displaying said data in order of a predetermined item, by selecting a predetermined communication counterpart when displaying said received/transmitted data in the order of a designated item.

Further, the present invention provides a cellular phone mentioned above, wherein the cellular phone is further provided with a function of selecting a communication partner, and setting a password to the transmission/reception data of the selected communication counterpart.

Still further, the present invention provides a cellular phone mentioned above, wherein the cellular phone is further provided with a function of forwarding electronic mail data to a designated address.

### BRIEF DESCRIPTION OF THE DRAWINGS

FIG. 1 is a block diagram of the configuration of the cellular phone;

FIG. 2 is a view showing the display with a list of displayed communication counterparts;

FIG. 3 is a view of the display showing the state where designated communication counterpart is C, and transmission/reception based on time is selected;

FIG. 4 is a flow chart showing the process of displaying both transmission/reception based on time, only transmission based on time, and only reception based on time, for a given communication counterpart; and

FIG. 5 is a view showing the conventional transmission/reception of electronic mail data.

### DETAILED DESCRIPTION OF PREFERRED EMBODIMENTS

The preferred embodiment of the present invention will now be explained based on examples and with reference to the accompanying drawings.

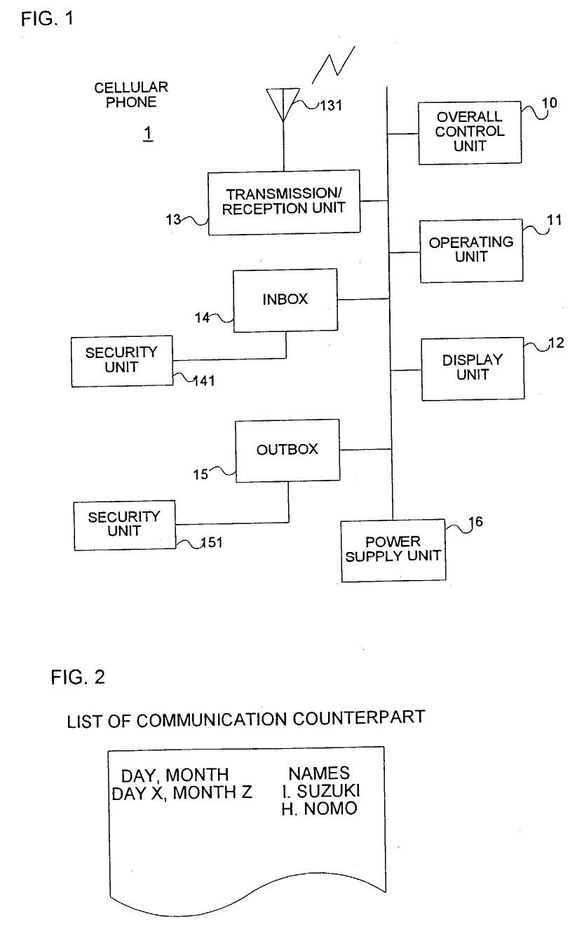

FIG. 1 is a block diagram showing the configuration of a cellular phone.

The cellular phone 1 is capable of receiving electronic mail data and transmitting created electronic mail data to a designated address, and is provided with an overall control unit 10, an operating unit 11, a display unit 12, a transmission/reception unit 13 for transmitting data to and receiving data from other devices via an antenna 131, an inbox 14 for storing received electronic mail data, an outbox 15 for storing transmitted electronic mail data, and a power source 16. The above-mentioned boxes are each equipped with a security unit, so that a password corresponding to the preset password is required in order to gain access to each of the boxes, thus providing confidentiality to the boxes. Such security measures are necessary to keep the contents hidden from a stranger, because cellular phones can be lost easily.

FIG. 2 shows a screen with a list of communication counterparts displayed thereon. The displayed list includes the date and the name of communication counterparts, enabling the use to select the desired communication counterpart by choosing a name on the list.

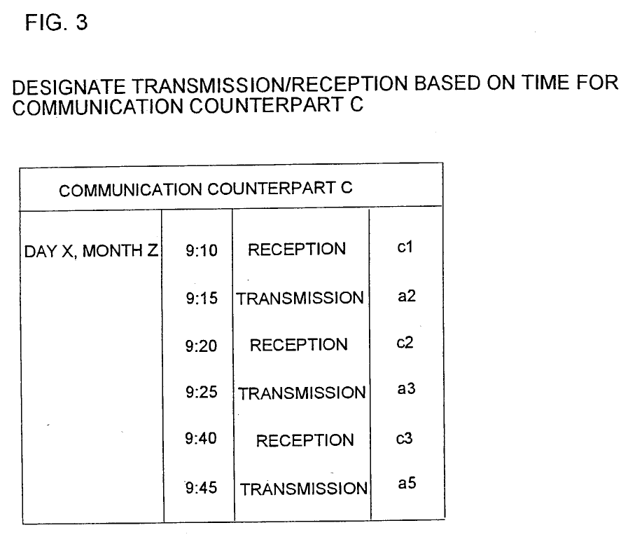

FIG. 3 shows an example of a display where the selected communication counterpart is C, with the display order based on time of transmission/reception selected. The transmission data sent to and the reception data received from the communication counterpart C are mixed and displayed in the order of time.

The content of the display is not limited to the example mentioned above, and data could be edited and displayed by reading out the data from inbox and outbox with respect to the communication counterpart and/or predetermined item (such as in the order of time or time group, the keyword included in a title and/or a content of transmission/reception (main text), or the title).

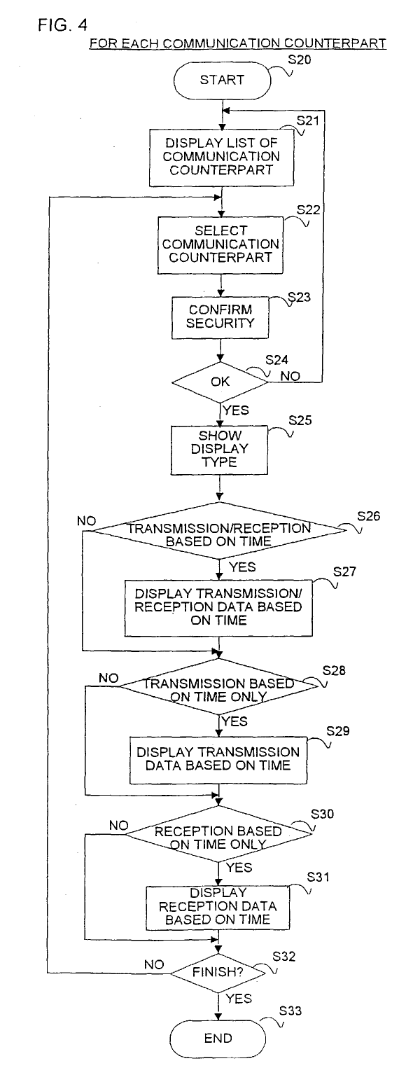

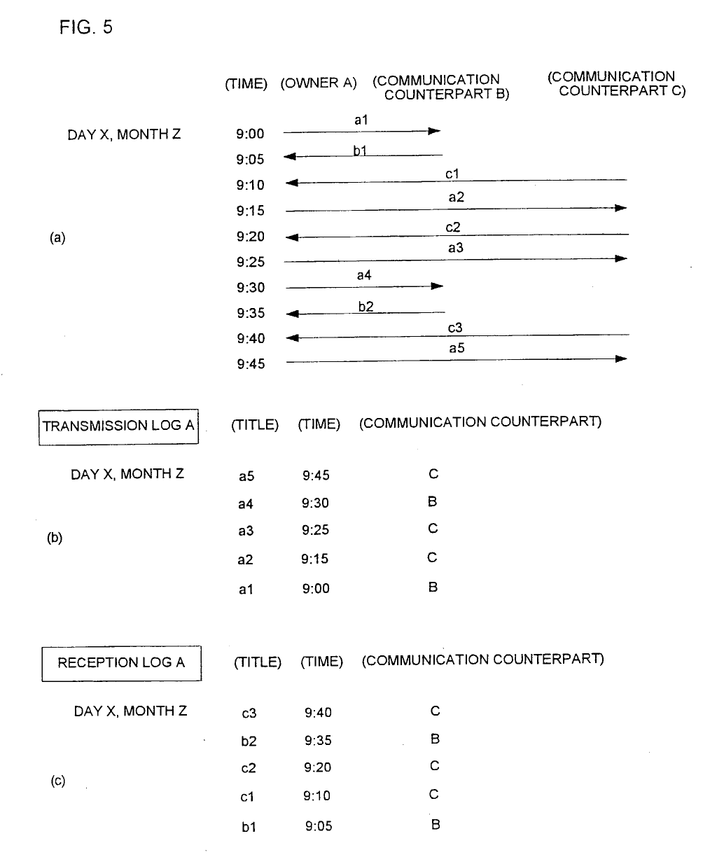

FIG. 4 is a flow chart showing the process of displaying information with respect to both transmission and reception based on time, only transmission based on time, and only reception based on time, for a given communication counterpart.

The process starts at step S20. In step S21, the list of communication counterparts is displayed as shown in FIG. 2. A particular communication counterpart (for example, C) is selected in step S22. In step S23, the confirmation of security is carried out, and if security cannot be confirmed in step S24, then the procedure returns to step S21. When the security is confirmed, then in step S25 the display type is displayed. In step S26, whether the display type is both transmission and reception based on time or not is determined. If it is both, then in step S27 the transmission and reception data based on time for communication counterpart C (name of the communication counterpart, date, time, transmission or reception, title) are displayed.

If step S26 is no (N), then the procedure advances to step S28. In step S28, it is determined whether or not the selected data type is only transmission based on time, and if it is only transmission, then in step S29 the transmission data based on time is displayed. In step S30, it is determined whether or not the selected data type is only reception based on time, and if this is not true, the procedure advances to step S32. If this is true, then in step S31 the reception data based on time is displayed. In step S32, it is determined whether the operation is completed or not. If it is not completed, then the procedure returns to step S22. If it is completed, then the procedure is terminated in step S33.

With the process mentioned above, the transmission/reception data based on time, or only the transmission data based on time, or only the reception data based on time for communication counterpart C can be displayed.

According to the present invention, the electronic mail data transmitted to and received from a designated communication counterpart may be displayed in a mixed state. Also, the transmitted/received electronic mail data for a given party may be edited and displayed with respect to a predetermined item (such as in the order of time or time range, the keyword included in a title and/or a content of transmission/reception (main text), or the title).

We claim:

1. A cellular phone provided with a function of editing and displaying electronic mail data for each communication counterpart, the cellular phone comprising an overall control unit, an operating unit, a display unit, a transmission/reception unit, an inbox for storing received electronic mail data, an outbox for storing transmitted electronic mail data, and a power source,
wherein said cellular phone is further provided with a function of displaying electronic mail data transmitted to and received from a selected communication counterpart in a mixed state.

2. A cellular phone provided with a function of editing and displaying electronic mail data for each communication counterpart according to claim 1,
wherein said cellular phone is further provided with a function of displaying electronic mail data in an order with respect to a predetermined item selected from the group consisting of time or time range, a keyword included in a title or content (main text), and a title.

3. A cellular phone provided with a function of editing and displaying electronic mail data for each communication counterpart according to claim 2,
wherein said cellular phone is further provided with a function of reading out reception data or transmission data with respect to a given communication counterpart, editing said data, and displaying said data in an order with respect to a predetermined item, by selecting a predetermined communication counterpart when displaying said reception data or transmission data in the order with respect to the predetermined item.

4. A cellular phone provided with a function of editing and displaying electronic mail data for each communication counterpart according to claim 1, claim 2 or claim 3,
wherein said cellular phone is further provided with a function of selecting a communication counterpart and setting a password to access the data transmitted to or received from said selected communication counterpart.

5. A cellular phone provided with a function of editing and displaying electronic mail data for each communication counterpart according to any one of claims 1 through 4,
wherein said cellular phone is further provided with a function of forwarding electronic mail data to a designated address.
